(19) United States
(12) Patent Application Publication
(10) Pub. No.: US 2007/0068425 A1
(43) Pub. Date: Mar. 29, 2007

(54) Process of inertization (dampening) of steel making slag for economical reuse

(76) Inventors: Joao Luiz Pimentel, Vila Velha (ES); Marco Valerio de Almeida Melo e Silva, Vitoria (ES); Nocv Oliveira-da Silveira, Vila Velha (ES); Ronaldo Lacourt de Mendonca, Vila Velha (ES); Marcio Carvalho de Mendonca, Serra (ES); Joao Oueres Ouindeler, Vila Velha (ES); Eudier Antonio da Silva, Vila Velha (ES)

Correspondence Address: VOLPE AND KOENIG, P.C., UNITED PLAZA, SUITE 1600, 30 SOUTH 17TH STREET, PHILADELPHIA, PA, 19103, US

(21) Appl. No.: 10/550,330

(22) PCT Filed: Oct. 15, 2004
(86) PCT No.: PCT/BR04/00203

§ 371 Date: Sep. 22, 2005

(30) Foreign Application Priority Data
Oct. 16, 2003 (BR) PI 0306767-0

(51) Int. Cl. C04B 28/08

(52) U.S. Cl. 106/789

(57) ABSTRACT

The Economic reuse of steel slag through its inertization (aeration and hydration), makes possible the inertization of this slag, as well as its reuse on road paving, now that its volumetric expansion is reduced to levels that do not compromise the structure and quality of these pavements.

### FIELD OF INVENTION

This invention refers to an economical process in which the steel slag can be reused, through inertization (aeration and hydration). Specifically, this invention refers to an improvement in the steel slag recycling.

### BACKGROUND

The steel alloys' manufacturing processes are well known, as well as the inherent residue generation, like mud and slag, of which the steel slag can be evidenced. Its technical application and environmentally adequate solution is the objective of the development of this process.

Collection and storage of the steel slag creates various problems like handling, transportation, loading, unloading and stocking for the huge amounts of this material, each of them with its own structure for environmental protection, especially water contamination.

Having in mind the rigorous inspection of environment protection agencies and social and environmental consciousness, metallurgical industries began researches seeking not only to avoid environmental damage due to their residue, as well as promoting the correct technical employment of these materials, and even making some profit through the application in road paving with asphalt coating as a replacement for petroleum compounds.

The LD steel slag is obtained in the pig iron to steel transformation process, on LD type converters, in which the oxides formed during the oxygen blow combine themselves with the dissolved CaO and MgO, creating the slag that is steady (stable) and distinct from the molten bath.

The utilization of LD slag in road pavement is well known in many countries since decades ago, and the problems that may happen in the paving using this kind of slag are well known too. Being worth of note is the volumetric expansion caused mainly by the CaO and MgO that are free from the slag, causing ruptures in the asphalt or concrete covering.

The term cured steel slag, commonly refers to the slag which is free from the risk of expanding, once it has been stored for a minimum period of 6 months, despite some texts affirming that the slag has to be stored for 01 a minimum (one) year, or even 02 (two) years, to be considered cured. However, the time variable is no the only responsible factor for the stabilization of the slag. The agents that cause the stabilization of the slag is water and atmospheric air through hydration and carbonation of the free CaO and MgO oxides, transforming them into stable hydrates and carbonates. Due to the hydraulic characteristics of the slag, rainwater, for instance, that falls on a pile of slag will react with the CaO and SiOa oxides, forming a film, obstructing, like this, the influx of water in the interior of the pile, slowing the curing process.

The difference between the cure conditions of the surface and the interior of the slag piles is one of the main factors that will result in problems in road paving, supposing, mistakenly, that the whole material is cured just for the fact of being stored for a minimum period of 06 months.

Because of this problem, which has become a worldwide matter, some alternatives to eliminate the volumetric expansion of the steel slag have been developed, achieving the inertization of the slag.

The most efficient solutions were identified in Europe and Japan, where volumetric expansion is reduced to near-zero levels. However, the cost benefit of these technologies was one of the responsible factors for making its access practically impossible in emerging economies.

What follows is a summary of some of the known processes.

KNOWN PROCESSES

—PROCESS: Increase of the fusible dissolution

DESCRIPTION: Granulometry reduction

MOMENT OF ACTUATION: Before generation

STRONG POINTS: Low Cost

WEAK POINTS: NIA

EFFECTIVENESS (Amount of Expansion Reduction): Not defined

—PROCESS: Alteration of the slagging agent

DESCRIPTION: Utilizing a synthetic material as fusible

MOMENT OF ACTUATION: Before generation

STRONG POINTS: Also increases the hydraulic activity of the slag

WEAK POINTS: Does not change the free MgO ratio

EFFECTIVENESS (Amount of Expansion Reduction): Low

—PROCESS: Silex and oxygen addition

DESCRIPTION: Silex and oxygen addition to the liquid slag with a heat source

MOMENT OF ACTUATION: After the generation, with the slag in liquid state

STRONG POINTS: Reduction in the free CaO and MgO ratios below the 1% level

WEAK POINTS: High Cost

EFFECTIVENESS (Amount of Expansion Reduction): Medium

—PROCESS: Granulation with water

DESCRIPTION: Abrupt cooling with water

MOMENT OF ACTUATION: After the generation, with the slag in liquid state

STRONG POINTS: Also increases the hydraulic activity of the slag

WEAK POINTS: Alteration in granulometry; drying needed; environmental problems

EFFECTIVENESS (Amount of Expansion Reduction): High

—PROCESS: Dry granulation

DESCRIPTION: Dry abrupt cooling

MOMENT OF ACTUATION: After the generation, with the slag in liquid state

STRONG POINTS: Also increases the hydraulic activity of the slag; simpler than granulation with water

WEAK POINTS: Alteration in granulometry

EFFECTIVENESS (Amount of Expansion Reduction): High

—PROCESS: Weathering

DESCRIPTION: Weather exposition—with occasional watering

MOMENT OF ACTUATION: After the generation, with the slag in solid state

STRONG POINTS: Low cost and simplicity

WEAK POINTS: Slow; Lacks a methodological definition, Heterogeneity

EFFECTIVENESS (Amount of Expansion Reduction): Variable

—PROCESS: Open yard steam cure

DESCRIPTION: Steam injection in the slag

MOMENT OF ACTUATION: After the Generation, with the slag in solid state

STRONG POINTS: Considerable reduction in free Cao and MgO ratios

WEAK POINTS: High cost, particularly if there is no steam tubing available

EFFECTIVENESS (Amount of Expansion Reduction): High

—PROCESS: SKAP steam cure

DESCRIPTION: Steam injection in the slag on a sterilizer

MOMENT OF ACTUATION: After the Generation, with the slag in solid state

STRONG POINTS: Considerable reduction in free CaO and MgO ratios

WEAK POINTS: High cost

EFFECTIVENESS (Amount of Expansion Reduction): Very high

### SUMMARY

The Economic Reuse of the Steel Slag through its inertization (aeration and hydration), is the result of researches and tests on experimental lots of LD slag, making possible the inertization of this slag, as well as its reuse on road paving, now that its volumetric expansion is reduced to levels that do not compromise the structure and quality of these pavements.

### BRIEF DESCRIPTION OF THE DRAWING(S)

Figure A is a photograph showing a ruptured asphalt layer used in the Prior Art.

Figure B is a photograph of an asphalt layer that used the present process.

Figure C is a table and graph showing an acceptance analysis.

### DETAILED DESCRIPTION OF THE PREFERRED EMBODIMENT(S)

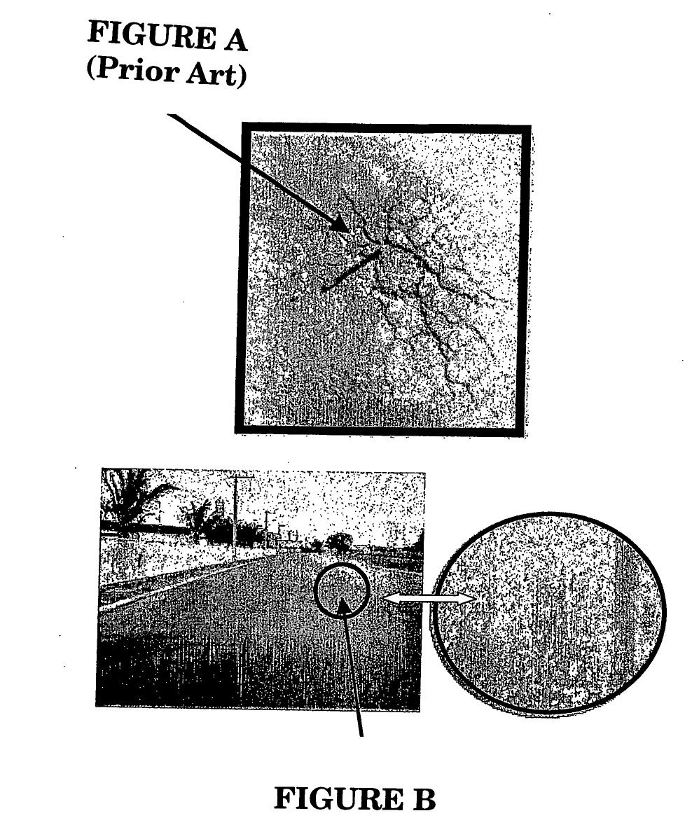

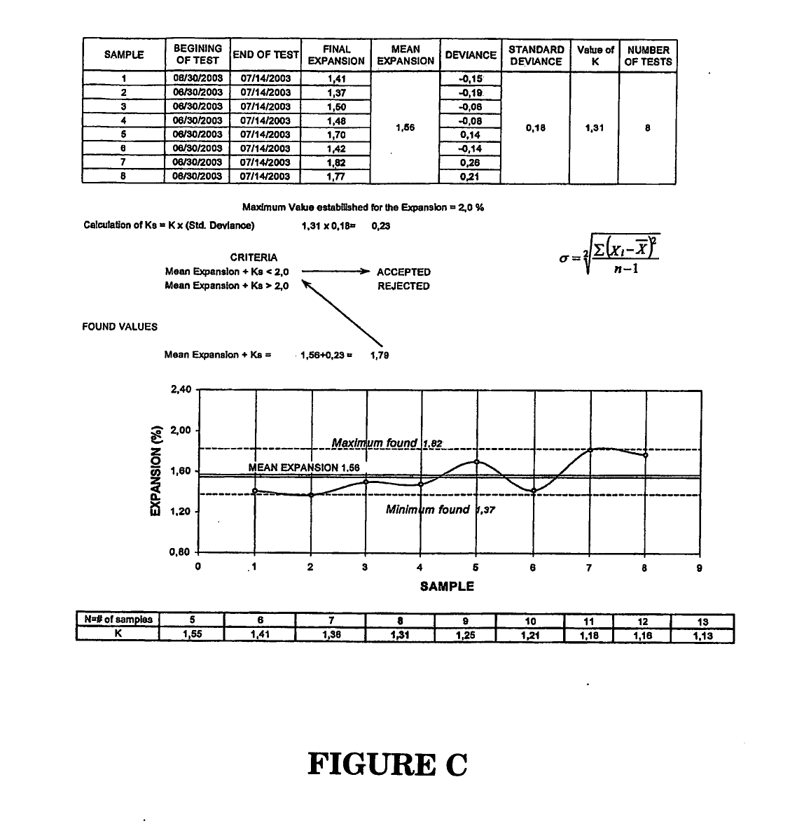

To make the process of economical reuse of steel slag through its inertization (aeration and hydration) better visualized, two photographs are attached to this report through FIG. 01. The first (A), shows a ruptured layer of asphalt because of the use of unprocessed slag, and on the second (B) shows an asphaltic layer applied over the steel slag that was inertized through the present process.

The Economic Reuse of the Steel Slag through its inertization (aeration and hydration) begins after the definition of an area to receive the slag, being prepared through topographical instructions that allow the proposed process to be carried out.

After the area is defined and adapted, it will be called inertization yard, where starts the process of unloading the slag, which will be laid through trucks and, later, through specific equipment, and distributed in homogenous way over the area until the previously defined thickness is achieved all over the area.

With the inertization yard prepared, the slag is ready to go through the process of aeration, process that starts with the movement of the slag with a leveling machine, a plough, a bulldozer or any other equipment capable of promoting the aeration of this material through its mixture, causing, subsequently, the acceleration of the carbonation of the free magnesium and calcium oxides existing in the slag, increasing the slag's contact with atmospheric air.

After the initial movement of the material laid in this yard, representative samples of the lot are taken for volumetric expansion level (initial volumetric expansion) analysis.

Simultaneously to the aeration process, the hydration process is done, through water aspersion with a water truck, or aspersers installed on the inertization yard, arranged in a way so that all the slag is reached, accelerating the hydration reactions of the oxides contained in the slag, especially the free magnesium and calcium oxides, which are the main responsible for the volumetric expansion of the slag.

These procedures are done daily, until the soil laboratory, responsible for the expansion level analysis, decides to halt the work, based on the periodic analysis of the volumetric expansion level of the slag lot being processed.

The water volume to be used during the inertization process will depend on the characteristic of each slag lot submitted to the process, once this characteristic depends on the type of produced steel, as well as other factors.

The ending of the inertization process of a certain lot of slag follows the control and quality criteria defined by the appropriate road standards, DNER-ES-301197 AND DNER-ES-303197 standards, on which the necessary amount of samples is indicated, as well as specific factors for acceptance analysis of a particular material lot (See Figure C).

For the residual volumetric expansion verification of the inertized product, the chosen method is the “PTM-130”, that was developed Pennsylvania Transportation Department (USA) and adapted by the Minas Gerais Highway Department DER/MG).

Besides the volumetric expansion test, it is necessary to verify the granulometry, the density, the ideal humidity and the California Support Index, vital evaluation characteristics of the aggregates to be used in the execution base and sub-base for road pavements.

With the process of Economic Reuse of the Steel Slag through its inertization (aeration and hydration), the LD steel slag, that has been adequately enhanced and submitted to the inertization process accordingly to the quality control criteria described above, can be used as aggregate in the execution of road work, as base and sub-base pavement element, as well as aggregate for asphaltic concrete.

1- ECONOMIC REUSE OF STEEL SLAG THROUGH INERTIZATION (AERATION AND HYDRATION) PROCESS, characterized by the reduction of volumetric expansion in steel slag, verified on in a laboratory by specific tests, seeking the slag's economical reuse in pavement base and sub-base, and asphaltic covering in road works.

2- ECONOMIC REUSE OF THE STEEL SLAG THROUGH INERTIZATION (AERATION AND HYDRATION) PROCESS, according to claim 1, characterized by an inertization yard, over which the steel slag will be laid and processed.

3- ECONOMIC REUSE OF THE STEEL SLAG THROUGH INERTIZATION (AERATION AND HYDRATION) PROCESS, according to claim 1, characterized by distribution of the steel slag over an inertization yard in a homogenous way.

4- ECONOMIC REUSE OF THE STEEL SLAG THROUGH INERTEATION (AERATION AND HYDRATION) PROCESS, according to claim 1, characterized by movement of the slag on an inertization yard using a leveling machine, a plough, a bulldozer or any other equipment capable of promoting the aeration of the slag through its mixture, which accelerates the carbonation of the free magnesium and calcium oxides existing in the slag.

5- ECONOMIC REUSE OF THE STEEL SLAG THROUGH INERTIZATION (AERATION AND HYDRATION) PROCESS, according to claim 1, characterized by initial representative sample analysis of a steel slag lot for verification of the volumetric expansion level of the steel slag.

6- ECONOMIC REUSE OF THE STEEL SLAG THROUGH INERTIZATION (AERATION AND HYDRATION) PROCESS, according to claim 1, characterized by hydration, through water aspersion over the slag with a water truck, or aspersers installed on the inertization yard, arranged in a way so that all the slag is reached, accelerating the hydration reactions of the oxides contained the slag, especially the free magnesium and calcium oxides, which are the main responsible for the volumetric expansion of the steel slag.

7- ECONOMIC REUSE OF THE STEEL SLAG THROUGH INERTIZATION (AERATION AND HYDRATION) PROCESS, according to claim 1, characterized by leaching and solubilisation of the steel slag, generating residues that will have other treatment.

8- A process for using steel slag for use in road paving, the process comprising:
defining an inertization yard for preparation of the slag;
placing slag within the inertization yard;
aerating the slag to accelerate carbonation of free magnesium and calcium oxides within the slag; and
hydrating the slag.
